(19) United States
(12) Patent Application Publication
(10) Pub. No.: US 2010/0107421 A1
(43) Pub. Date: May 6, 2010

(54) CONVERTIBLE CUTTING INSTRUMENT

(75) Inventors: Jonathan Newman Cedar, Scarsdale, NY (US); Przemyslaw Godycki, Brooklyn, NY (US)

Correspondence Address: WOLF GREENFIELD & SACKS, P.C., 600 ATLANTIC AVENUE, BOSTON, MA, 02210-2206, US

(73) Assignee: Staples The Office Superstore, LLC, Framingham, MA (US)

(21) Appl. No.: 12/264,468

(22) Filed: Nov. 4, 2008

(51) Int. Cl. B26B 13/12

(52) U.S. Cl. 30/232

(57) ABSTRACT

Described embodiments relate to a convertible cutting instrument with improved safety. In particular, some embodiments relate to a convertible cutting instrument that may be safely handled while blades of the cutting instrument are in a closed position, with no exposed cutting edges. Some further embodiments relate to a convertible cutting instrument that comprises only two cutting edges, both of which are inwardly-facing when the cutting instrument is in a dual-blade configuration. This may render the cutting instrument safer for use as a pair of scissors or shears. A conversion mechanism may be used to convert an inwardly-facing cutting edge into an outwardly facing cutting edge, so that the cutting instrument may be used as a knife.

### BACKGROUND OF INVENTION

1. Field of Invention

Embodiments of the invention relate to cutting instruments that are convertible between a dual-blade configuration and a single-blade configuration.

2. Discussion of Related Art

A typical dual-blade cutting instrument, such as a pair of scissors or shears, includes two blades pivotally coupled to each other. Each of the two blades is further coupled to a handle, so that a user may cause the two blades to rotate toward each other by grasping the handles. As the two blades rotate toward each other, an object placed between the blades, e.g., a piece of cloth or paper, is sheared by the sharp edges of the blades. Such a dual-blade cutting instrument allows the user to control the curvature of the cut by turning the object in relation to the blades or by turning the blades in relation to the object. It may also allow a user to cut relatively hard objects, such as metal wires and tree branches, by squeezing the handles together.

A typical single-blade cutting instrument, such as a knife, comprises a single blade attached to a handle, so that a user may use the blade to chop, slit, or stab objects by grasping the handle. Such a single-blade cutting instrument allows the user to make cuts quickly and efficiently, although the user may have less control over the shape of the cut.

As explained above, dual-blade and single-blade cutting instruments are useful in different ways. It is advantageous to provide a cutting instrument that is convertible between a dual-blade configuration and a single-blade configuration, so that the user may obtain greater utility from a single tool. Several variants of a scissors and knife combination have been proposed, e.g., in U.S. Pat. Nos. 1,771,031, 3,835,533, and 4,528,707.

### SUMMARY OF INVENTION

Various embodiments of the invention relate to a convertible cutting instrument with improved safety. In accordance with some embodiments of the invention, a convertible cutting instrument is operable as a pair of scissors in a dual-blade configuration and as a knife in a single-blade configuration. When in the dual-blade configuration, the convertible cutting instrument may comprise no outwardly facing cutting edges. The convertible cutting instrument may further comprise one or more safety mechanisms adapted to prevent the cutting instrument from entering into the single-blade configuration until the safety mechanism is released. Methods for converting a convertible cutting instrument between a dual-blade configuration and a single-blade configuration are also described.

One embodiment of the invention is directed to a convertible cutting instrument comprising a first blade, the first blade comprising a first cutting edge and a first outer edge opposite the first cutting edge, and a second blade pivotally coupled to the first blade, the second blade comprising a second cutting edge and a second outer edge opposite the second cutting edge. When the first and second blades are in an open position, the first blade is angularly displaced from the second blade with the first and second cutting edges facing inward. When the first and second blades are in a closed position, the first and second blades substantially overlap and the first cutting edge does not extend beyond the second outer edge. The convertible cutting instrument further comprises a conversion mechanism to convert the cutting instrument from a dual-blade configuration, in which the first and second blades are movable between the open position and the closed position to perform a cutting operation, to a single-blade configuration, in which the first cutting edge extends at least partially beyond the second outer edge to form an outwardly facing cutting edge.

Another embodiment of the invention is directed to a method for using a cutting instrument comprising first and second blades pivotally coupled to each other, the first blade comprising a first cutting edge and a first outer edge opposite the first cutting edge, and the second blade comprising a second cutting edge and a second outer edge opposite the second cutting edge. The method comprises cutting an object using the first and second cutting edges by rotating the first and second blades toward each other in a scissors-like motion, and converting the cutting instrument from a dual-blade configuration to a single-blade configuration by displacing the first blade in relation to the second blade to expose at least a portion of the first cutting edge.

A further embodiment of the invention is directed to a convertible cutting instrument comprising a first blade comprising a first cutting edge and a first outer edge opposite the first cutting edge, the first outer edge being substantially blunt; a first handle attached to the first blade; a second blade pivotally coupled to the first blade, the second blade comprising a second cutting edge and a second outer edge opposite the second cutting edge, the second outer edge being substantially blunt; and a second handle attached to the second blade. The first and second blades are adapted to rotate in relation to each other. The first and second cutting edges face each other when the first and second blades are in an open position, in which the first and second blades are angularly displaced from each other. The first and second cutting edges are adapted to shear an object placed between the first and second blades when the first and second blades rotate from the open position to a closed position, in which the first and second blades are substantially overlapping and the first cutting edge does not extend beyond the second outer edge. The convertible cutting instrument further comprises a bias mechanism adapted to bias the first and second blades into the closed position, and a conversion mechanism that, when actuated, overcomes the bias mechanism and causes the first and second blades to enter into a single blade configuration, wherein the first cutting edge extends beyond the second outer edge to form an outwardly facing cutting edge.

### BRIEF DESCRIPTION OF DRAWINGS

FIG. 1A is a side view of a prior convertible cutting instrument with blades in an open position;

FIG. 1B is a side view of the convertible cutting instrument of FIG. 1A with blades in a closed position;

FIG. 2A is a perspective view of a convertible cutting instrument in accordance with an exemplary embodiment of the invention;

FIGS. 2B-F are side views of the convertible cutting instrument shown in FIG. 2A, partially cut away to illustrate a lock mechanism;

FIG. 2G is a side view of an alternative embodiment of the convertible cutting instrument shown in FIG. 2A, partially cut away to illustrate an alternative lock mechanism;

FIG. 3SA is a perspective view of a convertible cutting instrument in accordance with another embodiment of the invention;

FIGS. 3B-C are side views of the convertible cutting instrument of FIG. 3A, partially cut away to illustrate a conversion mechanism;

FIG. 3D is a side view of the convertible cutting instrument of FIG. 3A, shown in a single-blade configuration; and

FIG. 3E is a side view of the convertible cutting instrument of FIG. 3A, partially cut away to illustrate a safety mechanism.

### DETAILED DESCRIPTION

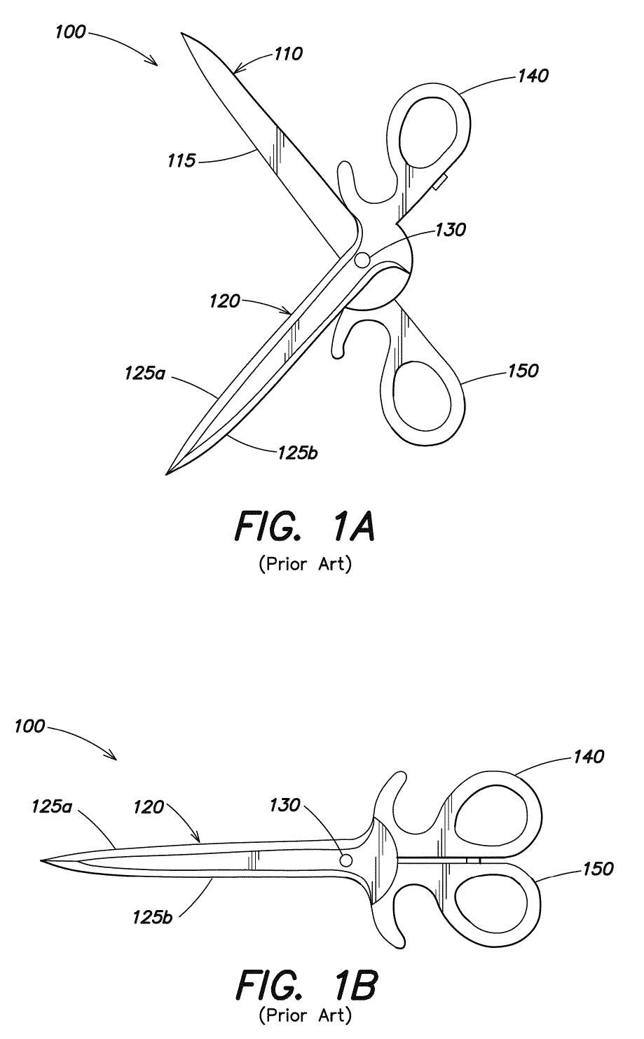

Applicant has appreciated that prior designs of convertible cutting instruments disclosed in U.S. Pat. Nos. 1,771,031, 3,835,533, and 4,528,707 have features that lead to some disadvantages. These features will be discussed below with reference to FIGS. 1A-B, which illustrate an example of the convertible cutting instrument of U.S. Pat. No. 4,528,707.

FIG. 1A shows convertible cutting instrument 100 with blades 110 and 120, which are pivotally coupled at a hinge 130, in an open position. The blades 110 and 120 are respectively coupled to handles 150 and 140. The blade 110 comprises a single cutting edge 115, while the blade 120 comprises two opposite cutting edges 125a-b. When using the instrument 100 as a pair of scissors, a user squeezes the handles 140 and 150 together, thereby causing the blades 110 and 120 to rotate toward each other to cut an object placed between the cutting edges 115 and 125a.

FIG. 1B shows the blades 110 and 120 of cutting instrument 100 in a closed position, in which both cutting edges 125a-b are exposed. The cutting instrument 100 may be used as a knife in this position, with cutting edges 125a-b forming cutting edges of the knife.

Applicant has appreciated a drawback of this type of design; namely, an outwardly facing cutting edge is exposed at all times. For example, the cutting edge 125b is outwardly facing and is exposed both when the blades are in the open position shown in FIG. 1A and when the blades are in the closed position shown in FIG. 1B. To avoid potential injuries caused by the cutting edge 125b, a user may need to take greater care while handling the instrument 100, as if handling a knife. For example, a sheath may be needed to prevent accidental contact with the cutting edge 125b when the blades of the instrument are in the closed position. By contrast, a conventional pair of scissors has no exposed outwardly facing blades, and therefore is safer to handle.

Embodiments described herein relate to a convertible cutting instrument with improved safety. In particular, some embodiments of the invention relate to a convertible cutting instrument that may be safely handled when the blades are in a closed position, with no exposed cutting edges. Some further embodiments of the invention relate to a convertible cutting instrument that comprises only two cutting edges, both of which are inwardly facing when the cutting instrument is in a dual-blade configuration. This may render the cutting instrument safer for use as a pair of scissors or shears.

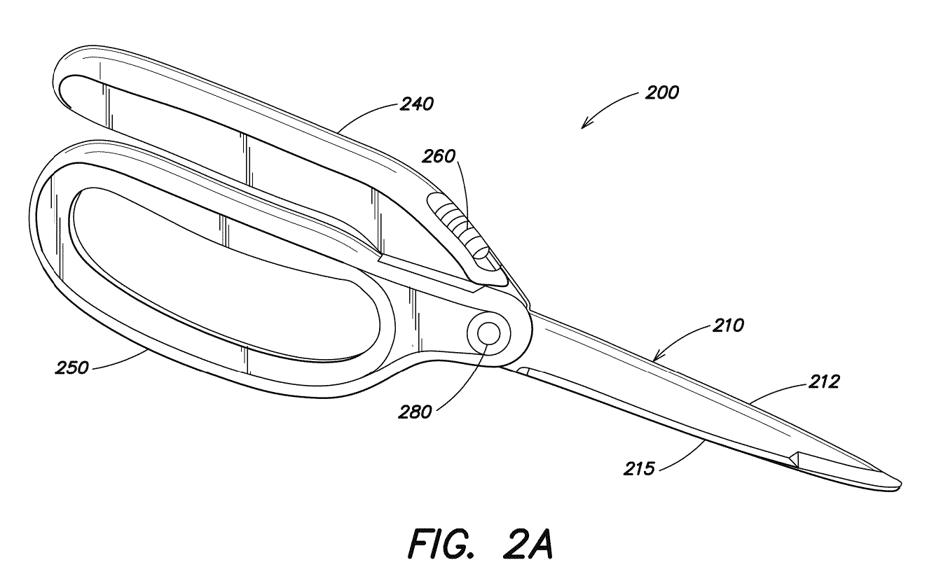

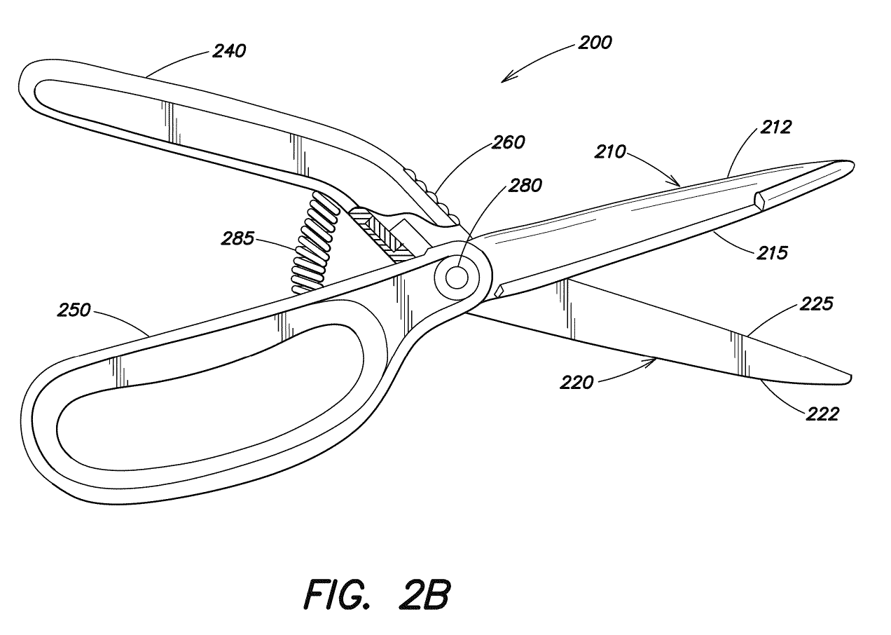

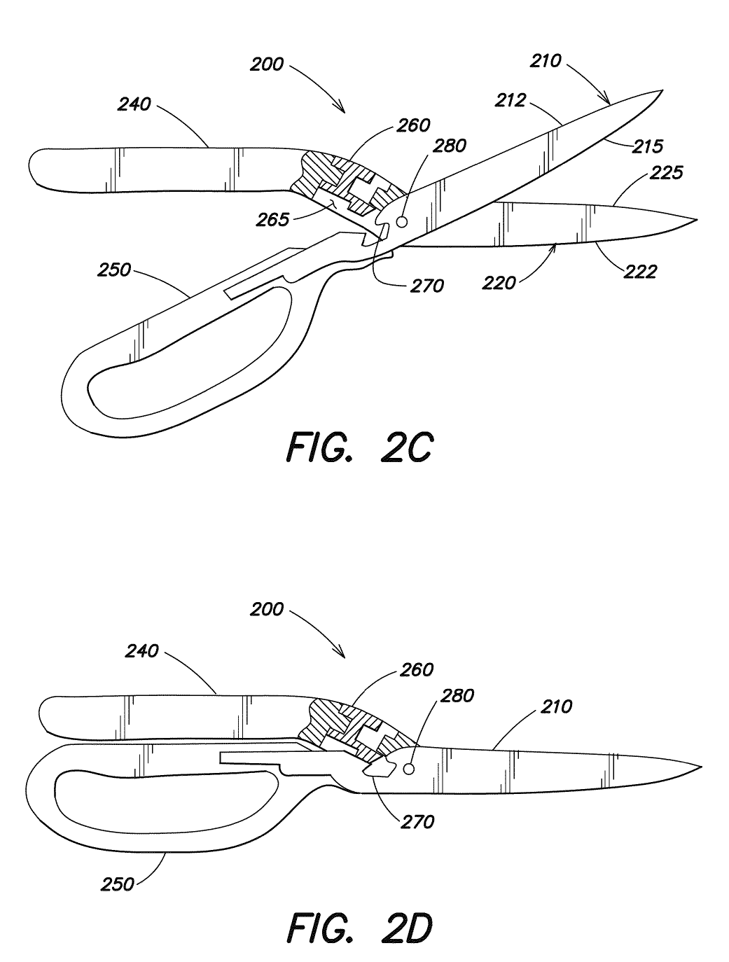

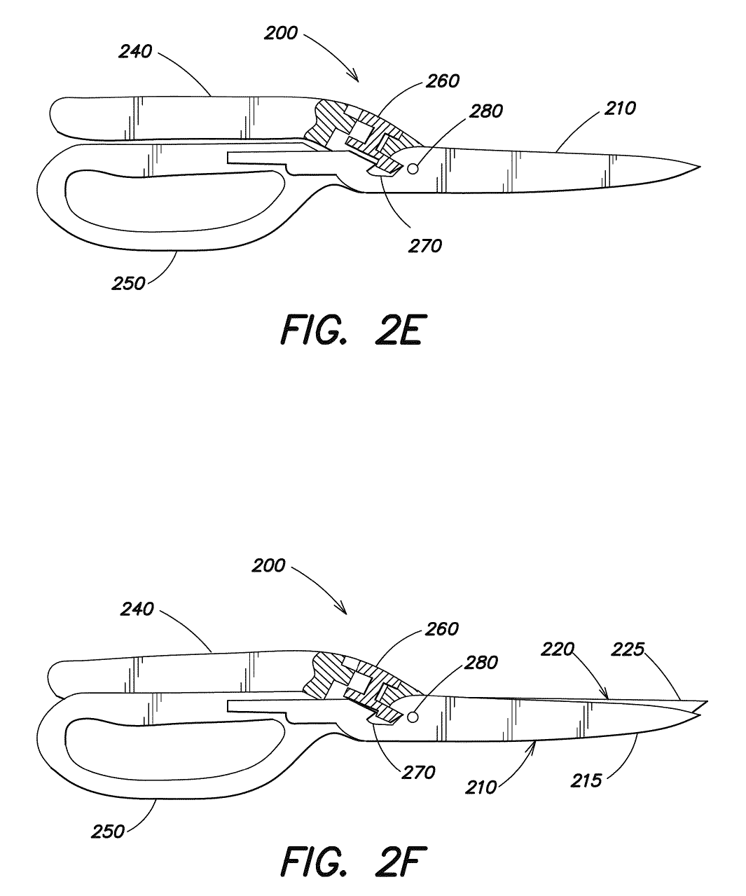

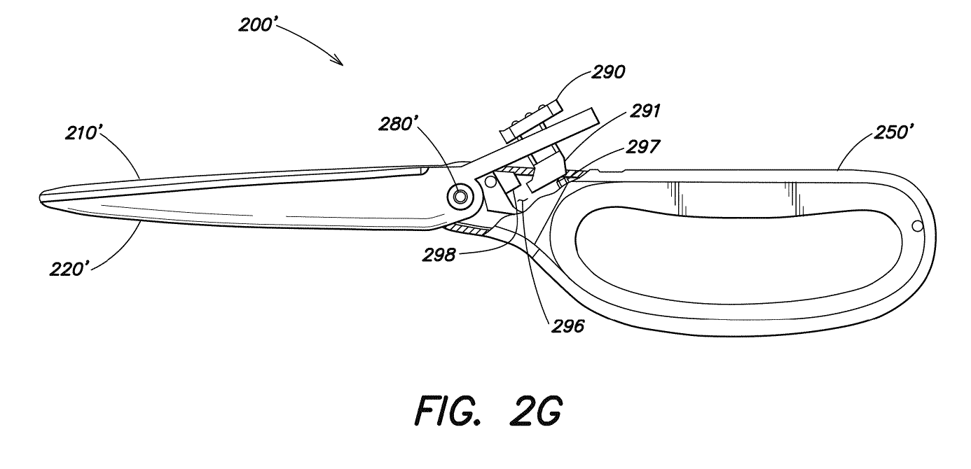

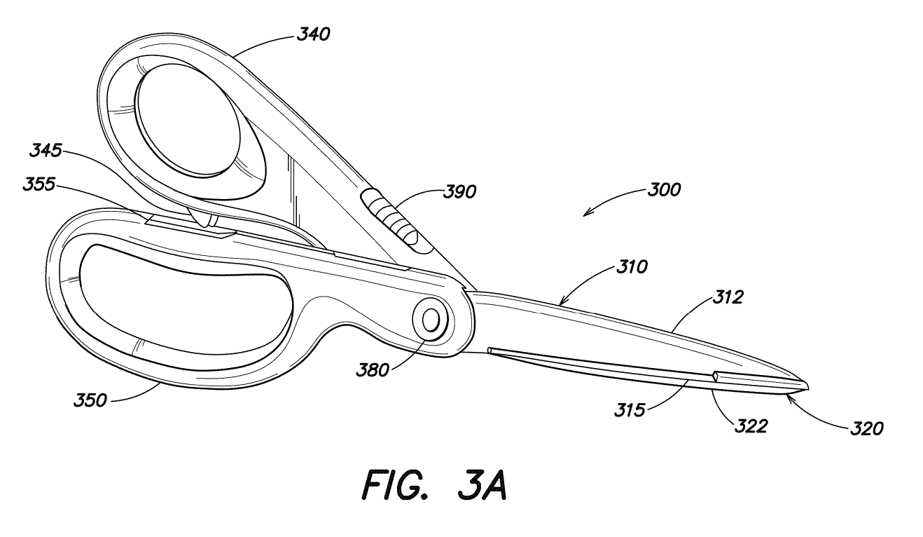

FIGS. 2A-F show an exemplary embodiment of a convertible cutting instrument 200 having a conversion mechanism that converts an inwardly facing cutting edge into an outwardly facing cutting edge, so that the cutting instrument 200 may be used as a knife. The cutting instrument 200 comprises blades 210 and 220. The blades 210 and 220 are pivotally coupled with each other at a hinge 280, and are attached respectively to handles 250 and 240. In the illustrated embodiment, the handle 240 is straight, while the handle 250 forms a loop through which a user may place one or more thumb and/or fingers. However, it should be appreciated that the invention is not limited to the particular handle configuration shown, and that each handle may be straight, looped, or have some other configuration.

The cutting instrument 200 is convertible between a dual-blade configuration in which the cutting instrument is operable as shears, and a single-blade configuration in which the cutting instrument is operable as a knife. In the dual-blade configuration, the blades 210 and 220 of the cutting instrument 200 are movable between an open position and a closed position. The dual-blade configuration is shown in FIGS. 2A and 2B.

FIG. 2A shows the blades 210 and 220 of the cutting instrument 200 in a closed position, and FIG. 2B shows the blades 210 and 220 of the cutting instrument 200 in an open position. As shown, the blade 210 comprises two edges: an outer edge 212 and a cutting edge 215. Similarly, the blade 220 comprises an outer edge 222 and a cutting edge 225. In this embodiment, the cutting instrument 200 also comprises a lock button 260, which will be described in greater detail below.

In the open position shown in FIG. 2B, the two blades 210 and 220 are rotated away from each other, exposing at least a portion of each of cutting edges 215 and 225. The cutting edges 215 and 225 face inward, towards each other. The cutting instrument 200 comprises a spring 285 as shown in FIG. 2B to bias the blades 210 and 220 of the cutting instrument 200 into the open position. Alternative bias mechanisms are possible, such as an elastic material, or the bias mechanism may be omitted so that no bias force is imposed on the blades or handles. Further, the bias mechanism may be applied as a pulling force and/or as a pushing force, and may be coupled to one or both of the blades 210 and 220 and/or one or both of the handles 240 and 250.

An object to be cut, e.g., a piece of paper or cloth, may be placed in the opening formed between the cutting edges 215 and 225 when the blades 210 and 220 are in the open position. To cut the object, a user of the cutting instrument 200 may squeeze the handles 240 and 250 together in a suitable way, causing the cutting edges 215 and 225 to rotate toward each other in a scissors-like motion. The object placed between the cutting edges 215 and 225 may be sheared as the cutting edges 215 and 225 rotate past each other, or otherwise when at least one cutting edge penetrates the object.

The user may continue to squeeze the handles 240 and 250 until the blades 210 and 220 at least substantially overlap, e.g., as in the closed position shown in FIG. 2A. The footprint of the pair of blades may be minimized, and the blade 220 may be obscured from view by the blade 210 as shown in FIG. 2A. However, it should be appreciated that the invention is not limited in this respect. For example, in other embodiments, the outer edge 222 may remain slightly below the cutting edge 215 when the blades 210 and 220 are in the closed position. Furthermore, the outer edge 222 may be substantially blunt and may serve as a shield that prevents potential injuries that may be caused by the cutting edge 215. Similarly, the outer edge 212 may be above the cutting edge 225 when the blades 210 and 220 are in the closed position, and may serve as a shield for the cutting edge 225.

As explained above, the blades 210 and 220 are biased into an open position in which the blades are angularly displaced with respect to each other and the cutting edges 215 and 225 are exposed. To overcome the bias without the need for continuously applied force by a user, a lock mechanism may be employed. In the embodiment illustrated in FIGS. 2A-F, a lock mechanism prevents blades 210 and 220 from entering an open position (e.g., as shown in FIG. 2B) until the lock mechanism is released. As shown in FIG. 2C, the lock mechanism comprises an aperture 270 formed on the blade 210 and a lock button 260 located on the handle 240. The lock button 260 may be adapted to slide back and forth within a lock button chamber 265 formed on the handle 240. For example, FIGS. 2C-D show the lock button 260 positioned at the back of the lock button chamber 265, and FIGS. 2E-F show the lock button 260 positioned at the front of the lock button chamber 265.

The lock button 260 and the lock button chamber 265 may be configured to enable at least a portion of the lock button 260 to become lodged within the aperture 270 to engage the lock mechanism. For example, starting from the configuration shown in FIG. 2D, the lock button 260 may be pushed forward so that a portion of the lock button 260 enters the aperture 270, and the lock button 260 and the aperture 270 form a male-female mating connection. This results in the configuration shown in FIG. 2E, in which the portion of the lock button 260 lodged within the aperture 270 prevents the blades 210 and 220 from rotating into the open position. To release the lock, the lock button 260 may be pushed back so that the lodged portion exits the aperture 270, returning the cutting instrument 200 to the configuration shown in FIG. 2D and allowing the blade 210 to rotate in relation to the blade 220. When a bias mechanism such as the spring 285 is included in the cutting instrument 200, as shown in FIG. 2B, the blades 210 and 220 may automatically rotate away from each other as soon as the lodged portion of the lock button 260 exits the aperture 270 and the lock mechanism is released.

It should be appreciated that the invention is not limited to the particular lock and/or bias mechanisms shown in FIGS. 2A-F, as many other alternative lock and/or bias mechanisms may also be suitable. For example, the aperture 270 may be located at a different location on the blade 210, or on the handle 250. One such alternative embodiment will be described in further detail below in connection with FIG. 2G. Also, the lock mechanism may comprise one or more mechanisms (e.g., springs) to bias the lock mechanism into either the released configuration (e.g., FIG. 2D) or the engaged configuration (e.g., FIG. 2E).

Turning to FIG. 2F, the cutting instrument 200 is shown in a single-blade configuration. To configure the cutting instrument 200 in this manner, the user may squeeze the handles 240 and 250 further toward each other, starting from the position shown in FIG. 2E wherein the blades 210 and 220 are in the closed position. The rotation may cause the blade 220 to rotate beyond the blade 210, thereby exposing the cutting edge 225. In FIG. 2F, the cutting edge 225 is exposed at least partially above the blade 210 and the cutting edge 215 is exposed at least partially below the blade 220. In this configuration, the cutting instrument 200 may be used as a knife, with the exposed cutting edges 225 and 215 forming the cutting edges of the knife. Alternatively, the single-blade configuration may include only one exposed cutting edge, such as one of cutting edge 225 or cutting edge 215.

To maintain the single-blade configuration, the lock mechanism described above may be actuated and a continuous squeezing force may be applied to the handles 240 and 250. Alternatively, a lock mechanism may be employed to lock the cutting instrument 200 in the single-blade configuration such that no squeezing force needs to be applied by the user.

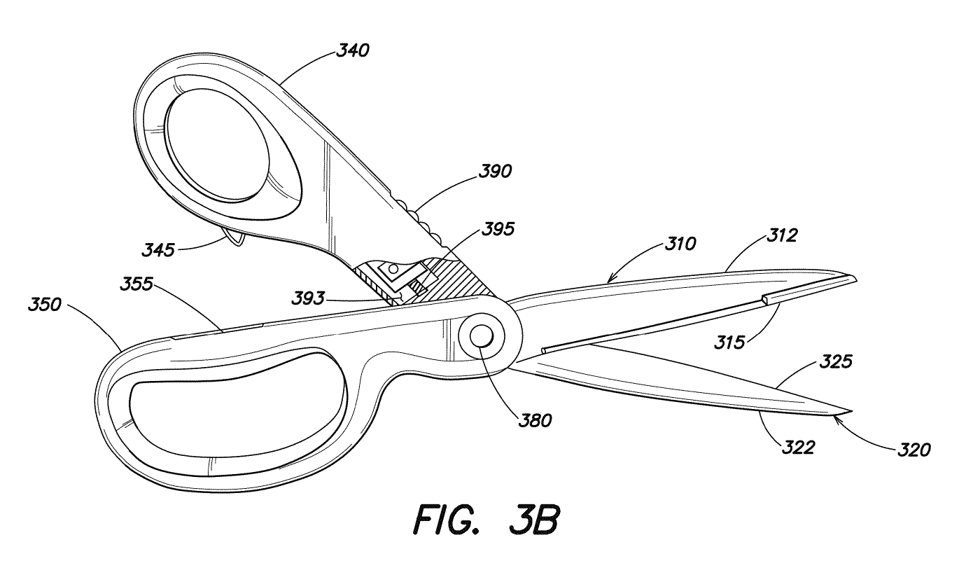

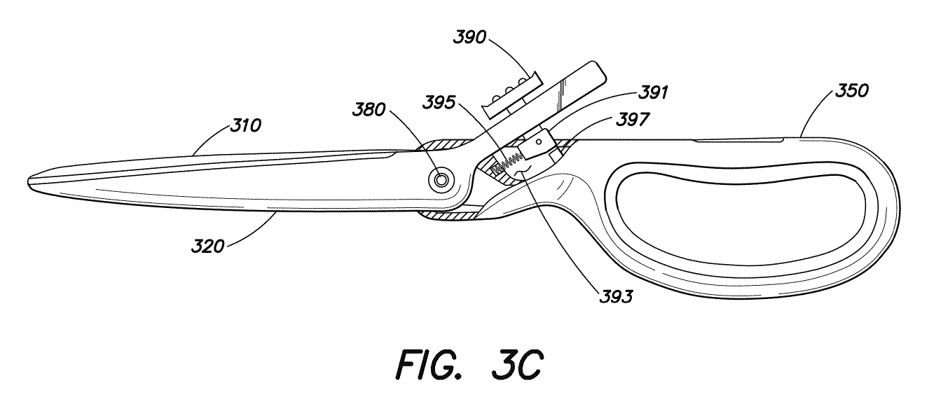

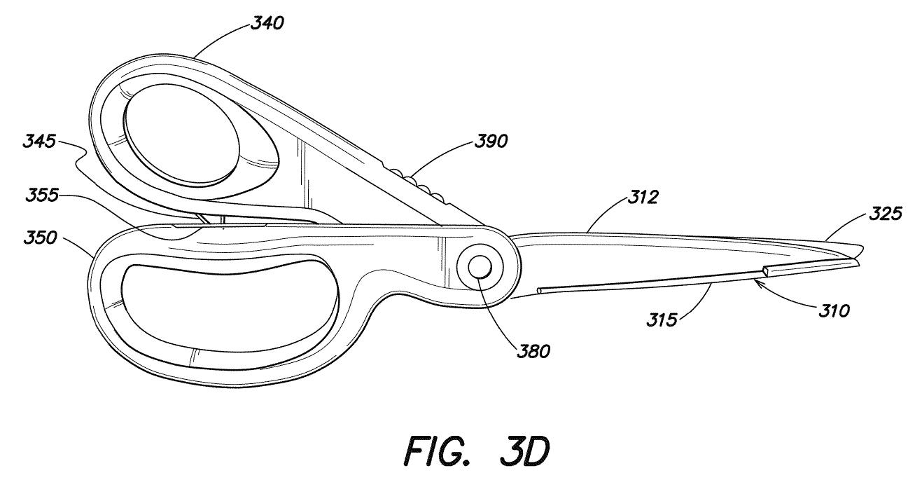

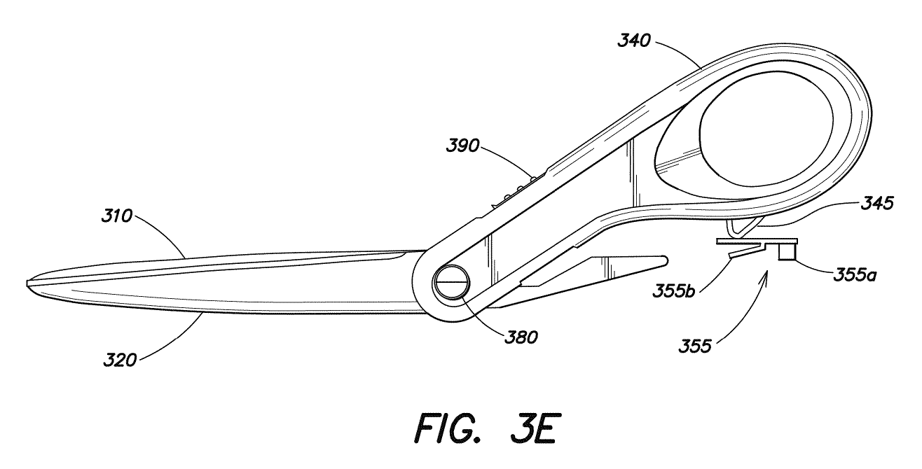

It should be appreciated that the conversion between the dual-blade configuration and the single-blade configuration may be accomplished in various ways other than that described above. For example, the cutting instrument may further comprise a conversion button, and the relative rotation of the blades 210 and 220 may be caused by applying pressure on the conversion button, instead of or in addition to squeezing the handles 240 and 250 toward each other. One such embodiment will be described in greater detail in connection with FIGS. 3A-E. Furthermore, the cutting edges of the single-blade configuration may be exposed by means other than by rotating the blades 210 and 220 with respect to each other. For example, the cutting instrument 200 may comprise a mechanism to displace, vertically and/or horizontally, at least one of the blades 210 and 220 in relation to the other.

As discussed above and illustrated in FIGS. 2A-F, the blades 210 and 220 of the cutting instrument 200 are biased into an open position and a lock mechanism is used to overcome the bias. In the embodiment shown in FIGS. 2C-F, the lock mechanism comprises an aperture 270 formed on the blade 210 and a lock button 260 located on the handle 240, where a portion of the lock button 260 is adapted to become lodged within the aperture 270 to engage the lock mechanism.

FIG. 2G, illustrates an alternative lock mechanism that may also be used to overcome a bias force. Particularly, FIG. 2G shows a cutting instrument 200′ having a lock button 290 adapted to engage/release the lock mechanism by sliding between two detents formed on a handle 250′ of the cutting instrument 200′. The cutting instrument 200′ comprises two blades 210′ and 220′ that are pivotally coupled to each other at a hinge 280′. The blade 210′ is coupled to the handle 250′, on which two detents 297 and 298 are formed. The detent 298 is located near the hinge 280′ and the detent 297 is located further away from the hinge 280′.

As shown in FIG. 2G, a portion 291 of the lock button 290 rests upon the detent 297 when the lock mechanism is released. In this configuration, the detent 297 may prevent the blades 210′ and 220′ from rotating past each other to enter into a single blade configuration similar to that shown in FIG. 2F. To engage the lock mechanism, a user may push the lock button 290 forward so that the portion 291 enters a cavity 296 bounded at least partially by the detent 298. The cavity 296 may be configured so that, whenever the portion 291 occupies a sufficient portion of the cavity 296, the detent 298 prevents the blades 210 and 220 from rotating into an open position similar to that shown in FIG. 2B. To release the lock mechanism, the lock button 260 may be pushed backward so that the portion 291 exits the cavity 296, returning the cutting instrument 200′ to the configuration shown in FIG. 2G and allowing the blades 210′ and 220′ to rotate into an open position.

FIGS. 3A-E illustrate another embodiment of the invention. According to this embodiment, a cutting instrument 300 is convertible between a dual-blade configuration in which the cutting instrument is operable as scissors, and a single-blade configuration in which the cutting instrument is operable as a knife. The convertible cutting instrument 300 comprises blades 310 and 320 that are pivotally coupled at a hinge 380 and are respectively attached to handles 350 and 340. Each of the handles 340 and 350 forms a loop through which a user may place one or more thumb and/or fingers. The blade 310 comprises a cutting edge 315 and an outer edge 312, and the blade 320 comprises a cutting edge 325 and an outer edge 322.

In the dual-blade configuration, the blades 310 and 320 of the cutting instrument 300 are movable between an open position and a closed position. The dual-blade configuration is shown in FIGS. 3A and 3B. FIG. 3A shows the blades 310 and 320 of the cutting instrument 300 in a closed position, and FIG. 3B shows the blades 310 and 320 of the cutting instrument 300 in an open position.

As shown in FIG. 3A, the blades 310 and 320 are in a closed position, with the blades 310 and 320 substantially, though not completely, overlapping. In particular, the cutting edge 315 is slightly above the outer edge 322. As discussed above, when the blades are in such a configuration, the outer edge 322 may serve as a shield to prevent potential injuries caused by the cutting edge 315, although the invention is not limited to the illustrated positions of the blades 310 and 320 or to the use of an outer edge as a shield for a cutting edge. Further, the blades may alternatively completely overlap in the closed configuration, and the blades may have the same footprint.

In the embodiment illustrated in FIGS. 3A-E, the handle 340 comprises a conversion button 390 to convert the cutting instrument 300 between a dual-blade configuration and a single-blade configuration. The conversion button 390 will be discussed in greater detail below in connection with FIGS. 3B-C. The handles 340 and 350 further comprise a safety mechanism to prevent the cutting instrument 300 from entering the single-blade configuration until the safety mechanism is released. The safety mechanism comprises a leaf spring component 355 formed on the handle 350 and a detent 345 formed on the handle 340, so that the detent 345 comes into contact with the leaf spring component 355 as the handles 340 and 350 are squeezed toward each other. The safety mechanism will be described in greater detail in connection with FIGS. 3D-E below.

FIG. 3B shows the blades 310 and 320 of the cutting instrument 300 in an open position, illustrating the conversion button 390. The conversion button 390 is housed in a conversion button chamber 393 formed within the handle 340 and is adapted to slide back and forth within the conversion button chamber 393. As described in connection with FIG. 3C, a user may push the conversion button 390 forward to convert the cutting instrument 300 from a dual-blade configuration (e.g., as shown in FIG. 3A) to a single-blade configuration (e.g., as shown in FIG. 3D).

The cutting instrument is shown in FIG. 3C with the handle 340 removed to illustrate the operation of the conversion button 390. As discussed above, the conversion button 390 is adapted to move from the front of the conversion button chamber 393 to the back of the conversion button chamber 393, and vice versa. As shown in FIG. 3C, the handle 350 comprises a detent 397 and, when the conversion button 390 is at the back of the chamber 393, a bottom portion 391 of the conversion button 390 is in contact with the detent 397. In such a configuration, the detent 397 prevents the handles 340 and 350 from rotating further toward each other, thereby preventing the blades 310 and 320 from entering into a single-blade configuration (e.g., as shown in FIG. 3D).

When the bottom portion 391 of the conversion button 390 is moved from the back of the chamber 393 to the front of the chamber, the bottom portion is no longer in contact with the detent 397, and the handles 340 and 350 are capable of rotating toward each other when a suitable torque is applied, thereby entering the blades 310 and 320 into the single-blade configuration. The torque may be applied in a number of different ways, as the invention is not limited in that regard. For example, a user may apply a force on the conversion button 390 at a suitable angle, so that the conversion button is moved from the back of the chamber 393 to the front of the chamber 393 and, at the same time, a torque is produced to rotate the handle 340 towards the handle 350. Alternatively, or additionally, the user may squeeze the handles 340 and 350 together when applying a force to move the conversion button 390 from the back of the chamber 393 to the front of the chamber 393.

Also shown in FIG. 3C is a spiral spring 395 coupled to the conversion button 390 to bias the conversion button 390 to the back of the chamber 393. When a force is applied to move the conversion button 390 from the back of the chamber 393 to the front of the chamber 393, the spiral spring 395 compresses against a front wall of chamber 393 to allow the movement of the conversion button 390. When no force is applied to the conversion button 390, the spiral spring 395 maintains the conversion button 390 in the back of the chamber 393, where the detent 397 prevents the handles 340 and 350 from rotating further toward each other and thereby prevents the blades 310 and 320 from entering into the single-blade configuration.

When a bias mechanism such as the spiral spring 395 is used, the user may need to apply force to the conversion button 390 continuously in order to maintain the cutting instrument 300 in the single-blade configuration. When the user releases the force, the cutting instrument 300 may automatically return to the dual-blade configuration. In particular, the blades 310 and 320 may return to the closed position. When a bias mechanism is not used, the cutting instrument 300 may remain in the single-blade configuration until the user applies a suitable force to return the conversion button 390 to the back of the chamber 393. As a further alternative, the cutting instrument 300 may comprise a lock mechanism that maintains the cutting instrument 300 in the single-blade configuration until the lock mechanism is released.

FIG. 3D shows the cutting instrument 300 in a single-blade configuration. To configure the cutting instrument 300 in this manner, the user may squeeze the handles 340 and 350 together, causing the detent 345 to compress the leaf spring component 355, as shown in FIG. 3D. The leaf spring component 355 is shown in its entirety in FIG. 3E, which shows the cutting instrument 300 with the handle 350 removed. As shown in FIG. 3E, the leaf spring component 355 is coupled to the handle 350 via a mount 355a, and comprises a leaf spring 355b that is compressed by the detent 345 when the handles 340 and 350 are squeezed together.

The squeezing of the handles 340 and 350, in conjunction with pushing the conversion button 390 forward, allows the blades 310 and 320 to rotate past each other to expose at least a portion of at least one of the cutting edges 315 and 325. For example, as shown in FIG. 3D, the cutting edge 325 rises at least partially above the outer edge 312, forming a cutting edge of a knife. Similarly, the cutting edge 315 extends at least partially below the outer edge 322 (obscured by the blade 310), forming another cutting edge of the knife.

As the user releases the handles 340 and 350, the leaf spring 355b returns to an uncompressed state, causing the blades 310 and 320 to return to the closed position, e.g., as shown in FIG. 3A. In this embodiment, the cutting edge 325 retracts to a position slightly below the outer edge 312, and the cutting edge 315 retracts to a position slightly above the outer edge 322. Thus, the detent 345 and the leaf spring component 355 form a safety mechanism that biases the blades 310 and 320 into the closed position, so that the cutting instrument 300 may enter the single-blade configuration only when the user applies pressure to squeeze the handles 340 and 350 together. Alternatively, the cutting instrument 300 could be configured such that a user does not need to apply a force to maintain the cutting instrument in the single-blade configuration.

It should be appreciated that, while a safety feature may be desirable, the invention is not limited to the inclusion of a safety feature. In an embodiment without a safety mechanism, it may be sufficient to activate a conversion mechanism (e.g., by holding the conversion button 390 forward) in order to convert the cutting instrument 300 to the single-blade configuration.

It should also be appreciated that the invention is not limited to the particular conversion and/or safety mechanisms shown in FIGS. 3A-E, as many other suitable conversion and/or safety mechanisms may be used. For example, the cutting instrument 300 may comprise a lock mechanism that, when engaged, prevents the cutting instrument from entering the single-blade configuration.

The convertible cutting instruments described herein may by formed using any suitable materials. For example, the blades 210, 220, 310, and 320 may be formed of steel (e.g., SK-5 steel), and the buttons 260 and 390 may be formed of one or more suitable plastic materials. The handles 240, 250, 340 and 350 may comprise plastic cores and thermoplastic rubber (TPR) outer casings. However, it should be appreciated that these are merely illustrative examples, as the invention is not limited to the materials used in forming various parts of a convertible cutting instrument.

Having thus described several aspects of some embodiments of this invention, it is to be appreciated that the present invention is not limited in its application to the details of construction and the arrangement of components set forth in the foregoing description or illustrated in the drawings. Various alterations, modifications, and improvements may readily occur to those skilled in the art. Such alterations, modifications, and improvements are intended to be within the spirit and scope of the invention. Accordingly, the foregoing description and drawings are by way of example only.

Further, although certain advantages of the devices and methods described herein have been expressed, these advantages are provided merely to illustrate potential applications, etc., of such devices and methods, and do not define necessary features of the invention. The phraseology and terminology used herein is for the purpose of description and should not be regarded as limiting. The use of “including,” “comprising,” or “having,” “containing,” “involving,” and variations thereof herein, is meant to encompass the items listed thereafter and equivalents thereof as well as additional items.

What is claimed is:

1. A convertible cutting instrument comprising:
a first blade comprising a first cutting edge and a first outer edge opposite the first cutting edge;
a second blade pivotally coupled to the first blade, the second blade comprising a second cutting edge and a second outer edge opposite the second cutting edge;
wherein, when the first and second blades are in an open position, the first blade is angularly displaced from the second blade with the first and second cutting edges facing inward and, when the first and second blades are in a closed position, the first and second blades substantially overlap and the first cutting edge does not extend beyond the second outer edge; and
a conversion mechanism to convert the cutting instrument from a dual-blade configuration, in which the first and second blades are movable between the open position and the closed position to perform a cutting operation, to a single-blade configuration, in which the first cutting edge extends at least partially beyond the second outer edge to form an outwardly facing cutting edge.

2. The cutting instrument of claim 1, wherein the first and second outer edges are substantially blunt.

3. The cutting instrument of claim 1, wherein the conversion mechanism comprises a conversion button, and wherein the conversion mechanism is engaged by actuating the conversion button.

4. The cutting instrument of claim 1, further comprising a first handle attached to the first blade and a second handle attached to the second blade, wherein the conversion button is formed on the first handle, and wherein actuating the conversion button allows the first and second handle to rotate toward each other.

5. The cutting instrument of claim 4, wherein actuating the conversion button comprises moving the conversion button from a first position to a second position, and wherein the second handle comprises a detent configured to prevent the cutting instrument from entering the single blade configuration when the conversion button is in the first position.

6. The cutting instrument of claim 1, further comprising a bias mechanism to return the cutting instrument from the single-blade configuration to the dual-blade configuration when the conversion mechanism is released.

7. The cutting instrument of claim 6, wherein the bias mechanism comprises a spring mechanism.

8. The cutting instrument of claim 1, further comprising at least one safety feature adapted to prevent the cutting instrument from entering the single-blade configuration until the at least one safety feature is released.

9. The cutting instrument of claim 8, further comprising a first handle attached to the first blade and a second handle attached to the second blade, wherein the at least one safety feature is released by squeezing the first and second handles toward each other.

10. The cutting instrument of claim 9, wherein the safety feature is re-engaged when the first and second handles are not squeezed toward each other.

11. The cutting instrument of claim 8, wherein the at least one safety feature comprises a safety button, and wherein the at least one safety feature is released by actuating the safety button.

12. The cutting instrument of claim 11, wherein the at least one safety feature is re-engaged when the pressure is removed from the safety button.

13. The cutting instrument of claim 1, further comprising a mechanism to bias the first and second blades into the open position.

14. The cutting instrument of claim 13, further comprising a lock mechanism adapted to prevent the first and second blades from entering the open position until the lock mechanism is released.

15. A method for using a cutting instrument comprising first and second blades pivotally coupled to each other, the first blade comprising a first cutting edge and a first outer edge opposite the first cutting edge, and the second blade comprising a second cutting edge and a second outer edge opposite the second cutting edge, the method comprising:
cutting an object using the first and second cutting edges by rotating the first and second blades toward each other in a scissors-like motion; and
converting the cutting instrument from a dual-blade configuration to a single-blade configuration by displacing the first blade in relation to the second blade to expose at least a portion of the first cutting edge.

16. The method of claim 15, wherein displacing the first blade in relation to the second blade comprises rotating the first cutting edge past the second outer edge.

17. The method of claim 15, wherein converting the cutting instrument comprises actuating a conversion button.

18. The method of claim 15, wherein the cutting instrument further comprises a first handle attached to the first blade and a second handle attached to the second blade, and wherein converting the cutting instrument comprises squeezing the first and second handles toward each other.

19. The method of claim 15, wherein converting the cutting instrument comprises releasing a safety mechanism that prevents the cutting instrument from entering the single-blade configuration until the safety feature is released.

20. The method of claim 19, wherein the cutting instrument further comprises a first handle attached to the first blade and a second handle attached to the second blade, and wherein the safety feature is released, at least in part, by squeezing the first and second handles toward each other.

21. A convertible cutting instrument comprising:
a first blade comprising a first cutting edge and a first outer edge opposite the first cutting edge, the first outer edge being substantially blunt;
a first handle attached to the first blade;
a second blade pivotally coupled to the first blade, the second blade comprising a second cutting edge and a second outer edge opposite the second cutting edge, the second outer edge being substantially blunt;
a second handle attached to the second blade, wherein:
the first and second blades are adapted to rotate in relation to each other;
the first and second cutting edges face each other when the first and second blades are in an open position, in which the first and second blades are angularly displaced from each other; and
the first and second cutting edges are adapted to shear an object placed between the first and second blades when the first and second blades rotate from the open position to a closed position, in which the first and second blades are substantially overlapping and the first cutting edge does not extend beyond the second outer edge;
a bias mechanism adapted to bias the first and second blades into the closed position; and
a conversion mechanism that, when actuated, overcomes the bias mechanism and causes the first and second blades to enter into a single blade configuration, wherein the first cutting edge extends beyond the second outer edge to form an outwardly facing cutting edge.
